(19) United States
(12) Patent Application Publication
(10) Pub. No.: US 2007/0120481 A1
(43) Pub. Date: May 31, 2007

(54) Self-emission panel and method of manufacturing the same

(75) Inventor: Toshiharu Aita, Yamagata (JP)

Correspondence Address: ARENT FOX PLLC, 1050 CONNECTICUT AVENUE, N.W., SUITE 400, WASHINGTON, DC, 20036, US

(73) Assignee: Tohoku Pioneer Corporation

(21) Appl. No.: 11/605,254

(22) Filed: Nov. 29, 2006

(30) Foreign Application Priority Data
Nov. 30, 2005 (JP) 2005-345581

(51) Int. Cl. H05B 33/00

(52) U.S. Cl. 313/512

(57) ABSTRACT

This invention is to save using additional area of self-emission panel substrate, thereby ensuring effective number of multi-faced unit panels; to reduce an area occupied by self-emission panel with respect to display area, thereby producing electronic device mounting self-emission panel which is compact in size and light in weight; to prevent a trouble such as cracking or the like when cutting/dividing a mother support substrate, thereby ensuring a high productivity irrespective of a shape of a self-emission panel substrate. A plurality of sealed self-emission sections are formed on a mother support substrate, connecting sections formed with lead-out wiring portions led out from the self-emission sections are formed outside the self-emission sections on the mother support substrate. Specifically, bent dividing lines La for sectioning in parallel protrusion areas protruding from neighboring self-emission sections to form the connecting sections are set in areas between neighboring self-emission sections on the mother support substrate. Further, hole processing portions are formed along partial or entire bent dividing lines, thereby making it possible to produce a plurality of unit self-emission panels simply by cutting along linear dividing lines.

### BACKGROUND OF THE INVENTION

The present invention relates to a self-emission panel and a method of manufacturing the same.

The present application claims priority from Japanese Application No. 2005-345581, the disclosure of which is incorporated herein by reference.

A self-emission panel represented by EL (Electroluminescence) display panel, PDP (Plasma Display Panel), and FED (Field Emission Display) panel is used as a flat-panel display or illumination means in various electronic devices. In particular, an organic EL panel can perform a color displaying which provides a desired brightness efficiency in various colors including R (Red), G (Green), and B (Blue). Further, an organic EL panel uses a driving voltage which is only several voltages to several tens of voltage, provides a high visibility even if it is viewed at an inclined angle, and has a high speed response with respect to a display changeover. Moreover, an organic EL panel can be made thinner than other types of display panels or made into a paper display.

Such a self-emission panel has a configuration which uses a sealing member to seal a self-emission section formed on a support substrate. With regard to an organic EL panel, it has been known that once organic EL elements of the self-emission section are exposed to open air, their light emission performance will become deteriorated. Accordingly, after the self-emission section has been formed on the support substrate, the support substrate and the sealing member (which may be a glass substrate or a metal sealing cover) will be bonded together so as to seal the self-emission section. Alternatively, the self-emission section formed on the support substrate is covered by a solid sealing member made of other materials to protect the self-emission section from open air.

In an actual process of manufacturing the above-described self-emission panel, in order to improve a production efficiency, a plurality of self-emission sections are formed on a mother support substrate, followed by covering the self-emission sections with sealing members and then cutting/dividing them into a plurality of unit display panels (refer to Japanese Unexamined Patent Application Publication No. 2002-352951).

FIG. 1 provides explanatory views showing an example for manufacturing conventional self-emission panels, in which unit self-emission panels are formed from a mother support substrate. As shown in FIG. 1A, at first, self-emission sections are formed on a plurality of positions on a mother support substrate J1, followed by bonding sealing members J2 to the mother support substrate J1, thereby covering the respective self emission sections. Then, the mother support substrate J1 is cut along predetermined cutting lines represented by chain lines, thereby producing a plurality of self-emission panels J10. Each of the self-emission panels J10, as shown in FIGS. 1B and 1C (FIG. 1B is a plan view and FIG. 1C is a side view), includes a divided support substrate J11 and a sealing member J2 bonded to the support substrate J11, while a driving IC J12 and a flexible substrate J13 are connected with lead-out wiring portions (now shown) extending from the sealing member J2 over the support substrate J11.

In the conventional technique discussed above, when the mother support substrate is cut into a plurality of self-emission panels, since the cutting process can effect only a linear cutting, the divided support substrates of the respective self-emission panels are all rectangular in shape. For this reason, like portion A shown in FIG. 1B, an additional area will be required to form a wiring lead-out section and a driving IC section which usually do not need a large area. As a result, the number of self-emission panels which can be divided from the mother support substrate has to be reduced, thus forming a potential factor causing an increased production cost. Besides, an increased area occupied by each unit self-emission panel makes it difficult to produce an electronic device (mounting a self-emission panel) which is compact in size and light in weight. Moreover, although it is possible to reduce the aforementioned additional area by making complex the cutting configuration of the mother support substrate, cutting into complex configuration is likely to cause cracking on corners, hence resulting in a low production yield and thus a low productivity.

### SUMMARY OF THE INVENTION

The present invention is to solve the aforementioned problem and makes this as one of its tasks. Namely, the present invention is to reduce an additional area in a self-emission panel substrate, ensure an acceptable number of divided substrates so as to reduce production cost, reduce other occupied area of a self-emission panel with respect to a display area, thereby making it possible to produce an electronic device mounting a self-emission panel which is compact in size and light in weight. Further, the present invention is to prevent cracking during a process of cutting the mother support substrate, thereby ensuring a high productivity irrespective of the configuration of a self-emission panel substrate.

In order to achieve the above objects, a self-emission panel and a method of manufacturing the same has at least the following features included in the following aspects.

According to one aspect of the present invention, there is provided a self-emission panel in which a sealed self-emission section is formed on a support substrate, and a connecting section formed with lead-out wiring portions led out from the self-emission section is formed outside the self-emission section on the support substrate. Specifically, at least one outer edge of the support substrate has a concave/convex portion for sectioning on one side a protrusion area protruding from the self-emission section to form the connecting section. In particular, the concave/convex portion is partially or entirely formed by virtue of hole processing edge.

According to another aspect of the present invention, there is provided a self-emission panel in which a plurality of sealed self-emission sections are formed on a mother support substrate, and connecting sections formed with lead-out wiring portions led out from the self-emission sections are formed outside the self-emission sections on the mother support substrate. Specifically, bent dividing lines for sectioning in parallel protrusion areas protruding from neighboring self-emission sections to form the connecting sections are set in areas between neighboring self-emission sections on the mother support substrate. In particular, hole processing portions are formed along partial or entire bent dividing lines.

According to a further aspect of the present invention, there is provided a method of manufacturing self-emission panels in which sealed self-emission sections are formed on support substrates, and connecting sections formed with lead-out wiring portions led out from the self-emission sections are formed outside the self-emission sections on the support substrates. This method comprises: a step of setting dividing lines for linearly sectioning surrounding areas of self-emission section forming regions on a mother support substrate on which a plurality of self-emission sections are to be formed, setting bent dividing lines for sectioning in parallel connecting section forming regions corresponding to neighboring self-emission section forming regions in areas between neighboring self-emission section forming regions on the mother support substrate, and forming hole processing portions along partial or entire bent dividing lines; a step of forming self-emission sections in the self-emission section forming regions on the mother support substrate and forming the connecting sections in the connecting section forming regions; a step of sealing the self-emission sections formed on the mother support substrate; and a step of linearly cutting/dividing the mother support substrate along the dividing lines to produce a plurality of self-emission panels.

### BRIEF DESCRIPTION OF THE DRAWINGS

These and other objects and advantages of the present invention will become clear from the following description with reference to the accompanying drawings, wherein:

FIG. 1 provides explanatory views showing a prior art;

FIG. 2 provides explanatory views showing an entire structure of a self-emission panel formed according to one embodiment of the present invention;

FIG. 3 is a plan view showing self-emission panels (which are self-emission panels before cutting/dividing mother support substrate) formed according to one embodiment of the present invention;

FIG. 4 provides explanatory views showing part of a mother support substrate on which self-emission sections are formed;

FIG. 5 provides explanatory views showing part of a mother support substrate on which self-emission sections are formed;

FIG. 6 provides explanatory views showing part of a mother support substrate on which self-emission sections are formed;

FIG. 7 is an explanatory view showing part of a mother support substrate on which self-emission sections are formed;

FIG. 8 is an explanatory view showing another embodiment of the present invention;

FIG. 9 is an explanatory flow chart showing a method of manufacturing self-emission panels according to an embodiment of the present invention; and

FIG. 10 is an explanatory view showing an example (organic EL panel) of the present invention.

### DETAILED DESCRIPTION OF THE PREFERRED EMBODIMENTS

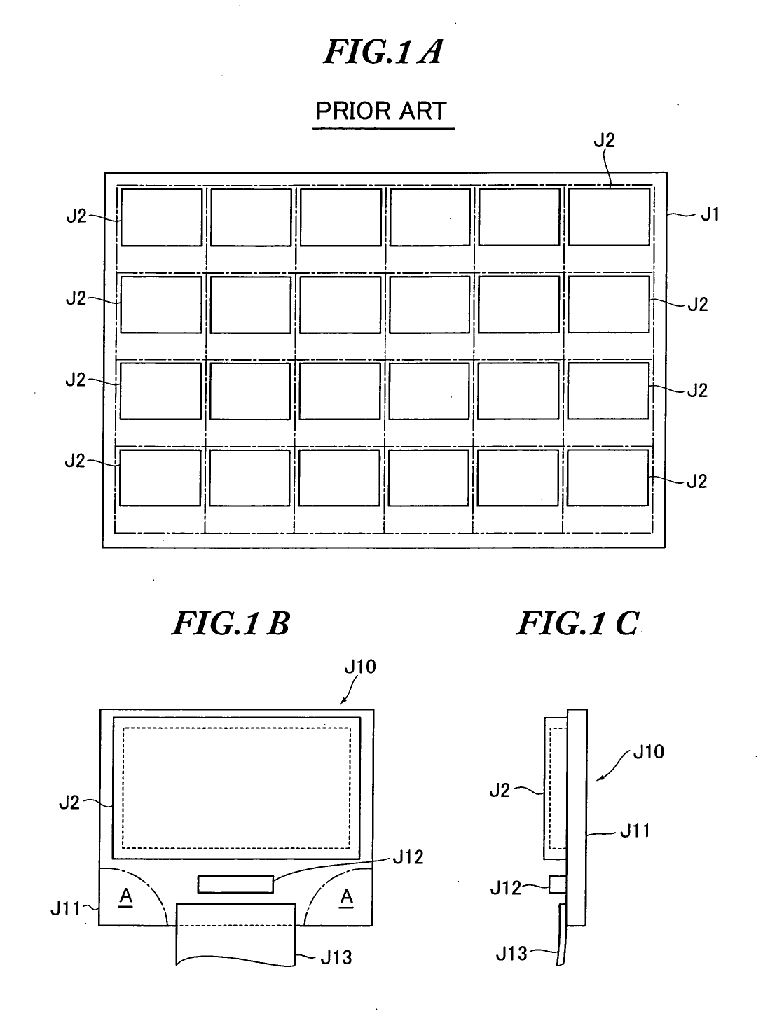

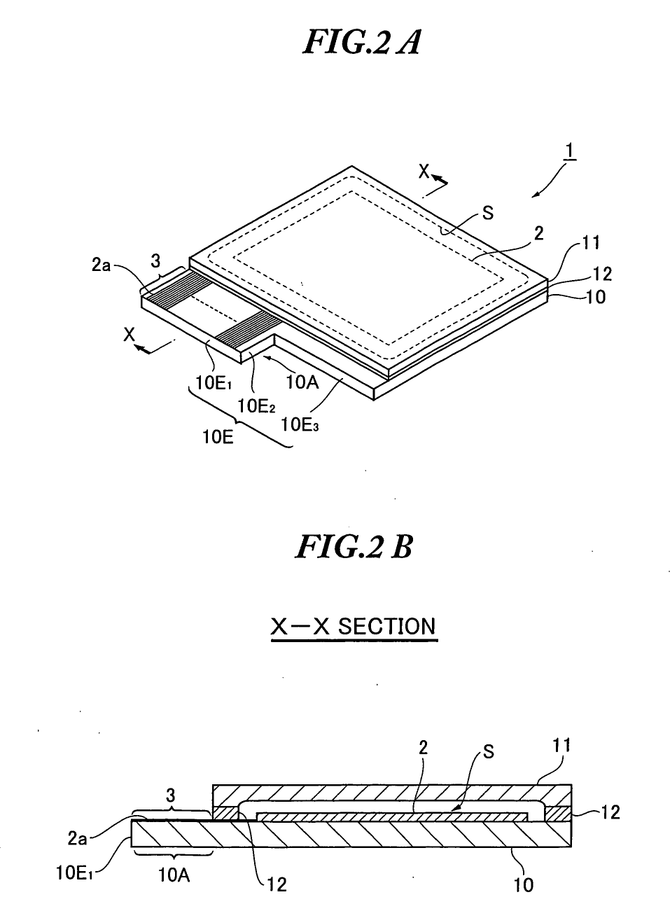

Hereafter, description will be given to explain embodiment of the present invention with reference to the accompanying drawings. FIG. 2 provides explanatory views showing an entire structure of a self-emission panel formed according to one embodiment of the present invention. FIG. 2A is a perspective view and FIG. 2B is a sectional view taken along X-X line in FIG. 1.

The self-emission panel 1 may be fabricated in the following way. Namely, at first, a self-emission section 2 is formed on the support substrate 10. Then, a sealing member 11 is bonded to the support substrate 10 through an adhesive layer 12 so as to form a sealing area S which accommodates the self-emission section 2. Afterwards, lead-out wiring portions 2a led from the self-emission section 2 out of the sealing area S are formed in a connecting section 3 provided outside the self-emission section 2 on the support substrate 10. The connecting section 3 is connected with a driving IC and a flexible substrate (not shown). Here, although the present embodiment shows that the sealing member 11 is bonded to the support substrate 10 to form the sealing area S, the self-emission panel 1 according to the present embodiment of the present invention can also be formed by covering and thus sealing the self-emission section 2 with other kind of solid sealing material.

Further, the self-emission panel 1 according to the present embodiment of the present invention is formed in a manner such that at least one outside of the support substrate 10 has a concave/convex portion 10E (10E₁-10E₂-10E₃) sectioning on one side a protrusion area 10A protruding from the self-emission section 2 to form the connecting section 3. Namely, when forming the protrusion area 10A forming the connecting section 3 on one side of the self-emission section 2 which has a rectangular shape, only one half is formed with such a protrusion area 10A, while the other half is formed with a notch of the support substrate 10.

Moreover, the concave/convex portion 10E (10E₁-10E₂-10E₃) is partially or entirely formed by virtue of hole processing edge. Here, so-called hole processing edge is formed through part of internal circumferential edge of hole processing portion formed in advance in the support substrate, thereby distinguishing itself from a cutting processing edge formed by cutting the support substrate 10. In the present embodiment, the concave/convex portion 10E includes a lateral edge 10E₁ located away from the self-emission section 2, another lateral edge 10E₃ located close to the self-emission section 2, and a vertical edge 10E₂ connecting the lateral edge 10E₁ with the lateral edge 10E₃. In this way, the protrusion area 10A is formed by virtue of the lateral edge 10E₁ and the vertical edge 10E₂, thereby forming a notch portion by virtue of the vertical edge 10E₂ and the lateral edge 10E₃. Further, the present embodiment of the present invention also includes those in which the concave/convex portion 10E as a whole is taken as hole processing edge, and those in which the vertical edge 10E₂ is made into a hole processing edge while the lateral edges 10E₁ and edges 10E₃ are formed by virtue of cutting processing edge.

According to the self-emission panel 1 of the present embodiment, since the protrusion area 10A of the support substrate 10 can be reduced in its area and since the connecting section 3 can be concentrically formed in this area, it is possible to save space in setting a self-emission panel 1. Besides, it is also possible to manufacture a self-emission panel which is less heavy than a conventional self-emission panel not having a notch portion in its support substrate.

Furthermore, when cutting out the support substrates 10 from a large mother support substrate, the foregoing notch portion can correspond to the protrusion area 10A of each support substrate 10 on the mother support substrate, thereby making it possible to carry out the cutting and dividing with reduced useless space, thus cutting support substrates 10 from the mother support substrate of a predetermined area with an acceptable efficiency. In this way, it is possible to reduce the production cost.

In deed, it is necessary to draw dividing lines corresponding to each concave/convex portion 10E (10E₁-10E₂-10E₃) in order to effect the cutting and dividing. However, since each concave/convex portion 10E (10E₁-10E₂-10E₃) is partially or entirely formed by virtue of hole processing edges formed in advance, it is allowed to use a conventional cutting process to perform the cutting and dividing without any problem such as cracking, provided that the cutting is performed along linear dividing lines. In particular, if each concave/convex portion 10E is entirely made into a hole processing edge in advance, it is allowed to omit the cutting of the concave/convex portion 10E. Further, if the vertical edge 10E₂ is made into a hole processing edge in advance, a cutting process to be performed along each concave/convex portion 10E can be completed only by cutting the lateral edges 10E₁, 10E₃.

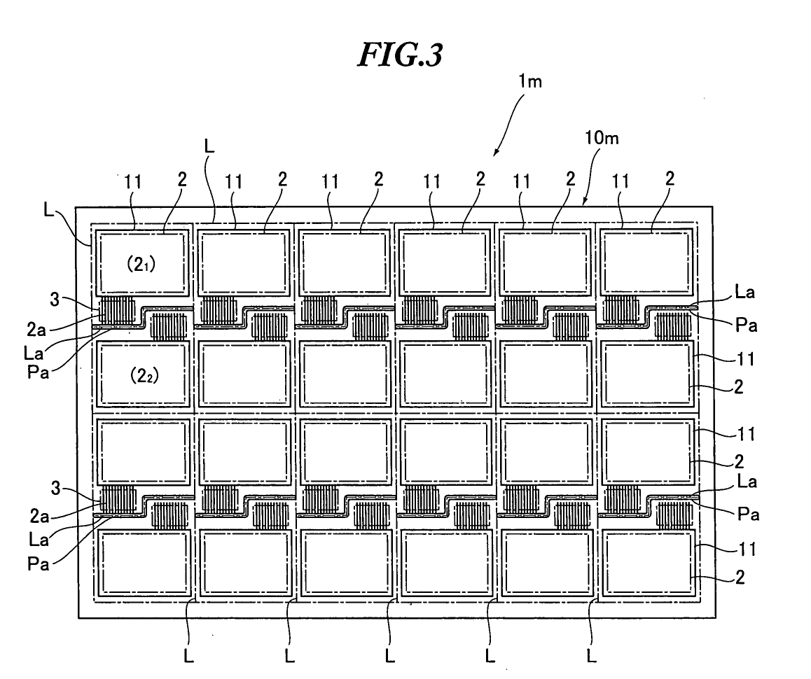

FIG. 3 is a plan view showing self-emission panels lm before cutting and dividing a mother support substrate 10m. The self-emission panels 1m are fabricated by forming a plurality of self-emission sections 2 sealed on the mother support substrate 10m, followed by forming the connecting sections 3 (each formed with lead-out wiring portions 2a extending from a self-emission section 2) in areas other than the self-emission sections 2 on the mother support substrate 10m. Further, in areas between every two mutually neighboring self-emission sections 2 on the mother support substrate 10m, dividing lines La are set which are bent and dividing the protrusion areas protruding from the mutually adjacent self-emission sections 2 to form the connecting sections 3, thereby forming hole processing portions Pa along part or entire bent dividing lines La.

Namely, the mother support substrate 10m is divided along dividing lines L, La sectioning the surrounding areas of the respective self-emission sections 2, thereby producing a plurality of self-emission panels 1 shown in FIG. 2. Here, with respect to the mother support substrate 10m, the bent dividing lines La are set to form hole processing portions Pa in advance. When the dividing lines L, La are set, the connecting sections 3 of neighboring self-emission sections 2 (2₁, 2₂) are arranged in mutually facing positions.

In this way, when performing cutting and dividing, an operation required is only to perform a linear cutting along linear dividing lines L, thereby cutting out a plurality of self-emission panels 1 each shown in FIG. 2. Therefore, it is possible to form a plurality of pairs of self-emission panels 1 on both sides of the bent dividing lines La, with each self-emission panel 1 carrying on one side thereof a protrusion portion mounting a connecting section 3. At this time, since hole processing is performed in advance along the bent dividing lines La and since it is not necessary to perform cutting during dividing process, it is possible to avoid cutting along complex zigzag lines, thereby preventing a trouble such as cracking which usually occurs during dividing operation. Moreover, since the concave and convex portions on the outer edges of the self-emission panels 1 are combined with one another on the mother support substrate 10, and since the dividing lines L, La are set in a manner such that the protrusion portions carrying the connecting sections 3 are arranged in parallel with one another, it is possible to obtain a desired number of multi-faced self-emission panels from the mother support substrate 10 having a predetermined area, thereby reducing the production cost when manufacturing the self-emission panels.

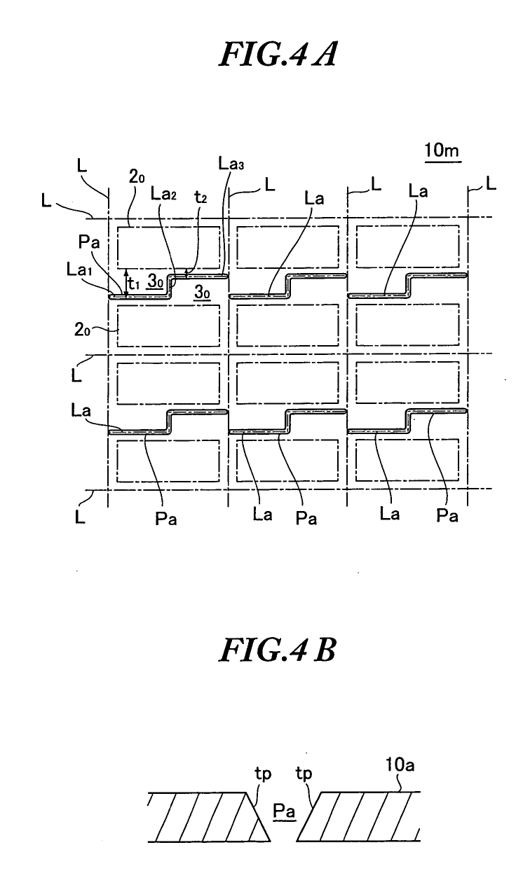

FIGS. 4-7 are explanatory views showing part of the mother support substrate 10m on which self-emission sections are formed. As shown, a plurality of self-emission section forming regions 2 ₀ are formed on the mother support substrate 10m, followed by setting dividing lines L for linearly dividing the mother substrate along the surrounding areas of the self-emission section forming regions 2₀. Further, the bent dividing lines La for sectioning the connecting section forming regions 3₀ corresponding to neighboring self-emission section forming regions 2₀ are formed in areas between neighboring self-emission section forming regions 2₀ on the mother support substrate 10m. As described above, the protrusion areas are formed on both sides of the dividing lines La.

In an example shown in FIG. 4, each bent dividing line La includes one lateral line La₁ separated a distance t1 from one of two neighboring self-emission section forming regions 2₀, another lateral line La₃ close (distance t2) to the one self-emission section forming region 2₀, and a vertical line La₂ connecting the lateral line La₁ with the lateral line La₃. In this example, the hole processing portions Pa are formed in the entire bent dividing line (including the lateral line La₁, the vertical line La₂ and the lateral line La₃).

Here, the hole processing portions Pa can be formed by etching, sandblasting, laser beam machining, or punching. In etching or sandblasting, tapered surfaces tp are formed on the inner edges of the hole processing portions pa of the mother support substrate 10m in a manner shown in FIG. 4B, thereby allowing the inner edges to serve as outer edges of the foregoing protrusion portions.

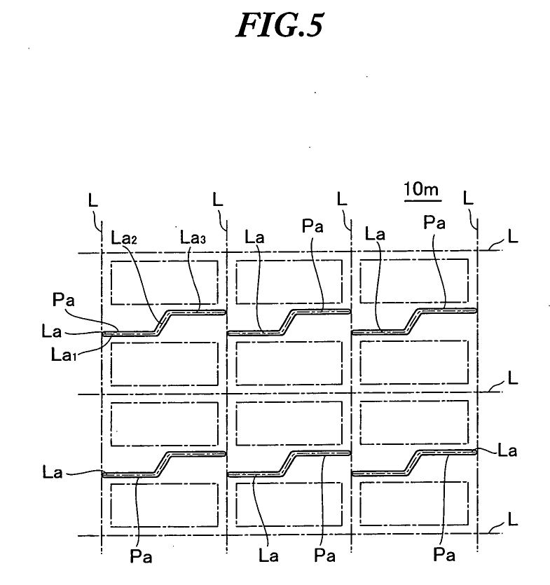

In an example shown in FIG. 5, similar to the example shown in FIG. 4, each bent dividing line La includes one lateral line La₁ separated a distance from one of two neighboring self-emission section forming regions 2₀, another lateral line La₃ close to the one self-emission section forming region 2₀, and a vertical line La₂ connecting the lateral line La₁ with the lateral line La₃. In this example, the vertical line La₂ is set in a slightly inclined state with respect to the lateral lines La₁ and La₃, thereby forming the hole processing portions pa along the entire dividing lines La.

In this example, since the dividing lines La are bent in an obtuse angle and processed along such dividing lines, it is possible to form the corner of each protrusion area into an obtuse angle, thereby avoiding a trouble such as corner deficiency. Moreover, it is possible to properly set an inclined angle of each vertical line La₂ according to wiring state of lead-out wiring portions.

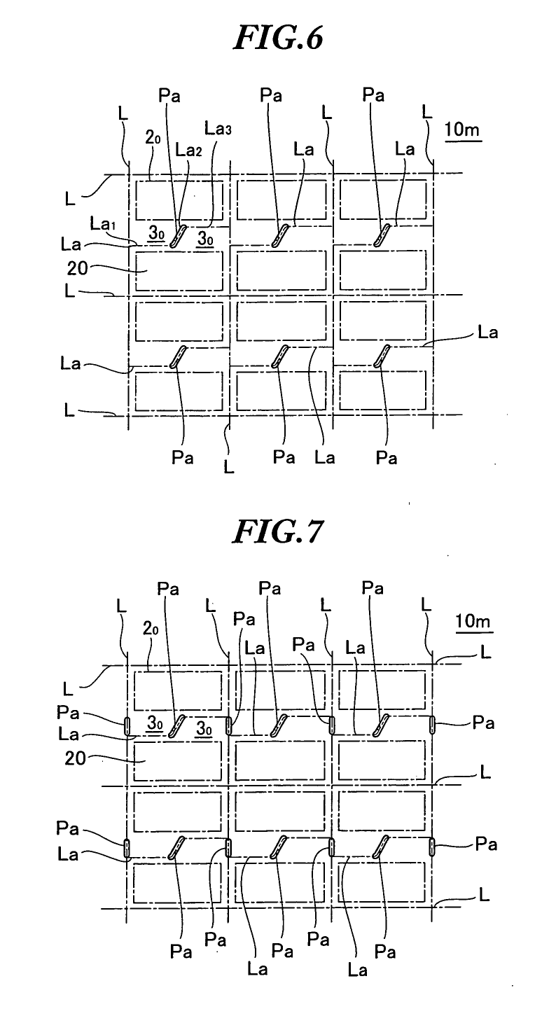

In examples shown in FIGS. 6 and 7, bent dividing lines La similar to those in the above-described examples are set, thereby forming hole processing portions Pa in part of the dividing lines La. In detail, an example illustrated in FIG. 6 shows that hole processing portions Pa are formed in vertical lines La₂, while an example illustrated in FIG. 7 shows that hole processing portions Pa are formed in vertical lines La₂ and linear dividing lines L. Here, the hole processing portions Pa are provided for cutting the bent dividing lines La only by performing a linear cutting. In the examples shown in the drawings, it is possible to cut out individual self-emission panels from the mother support substrate 10m only by performing the cutting along the linear dividing lines L and the lateral lines La₁ and La₃.

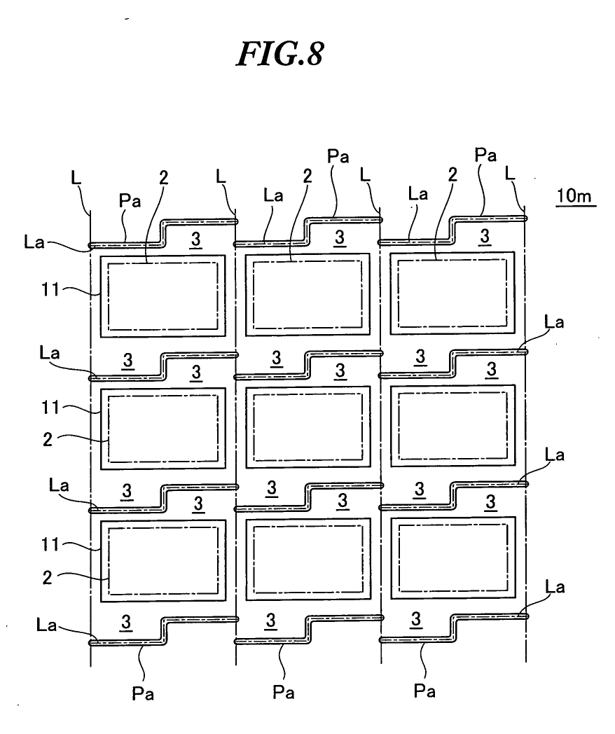

FIG. 8 shows another embodiment of the present invention, illustrating that each self-emission panel cut out from the mother support substrate 10m has two protrusion areas. Here, in order to form two connecting sections 3 on two mutually opposed sides of each self-emission section 2, bent dividing lines La are set in areas between self-emission sections 2, followed by forming hole processing portions Pa along these dividing lines La. In this way, it is possible to cut out respective self-emission panels only by performing a cutting operation along the dividing lines L arranged in parallel in the longitudinal direction. Moreover, it is also possible for the lead-out wiring portions to be orientated in multiple directions.

In the above-described embodiments, the bent dividing lines La are set in a manner such that it is possible to cut out self-emission panels having the same shape. However, the present invention should not be limited by this. Actually, it is also possible to set complexly bent dividing lines La in a manner such that one of every two neighboring self-emission panels has a protrusion area in center, while the other has protruding areas on both ends thereof.

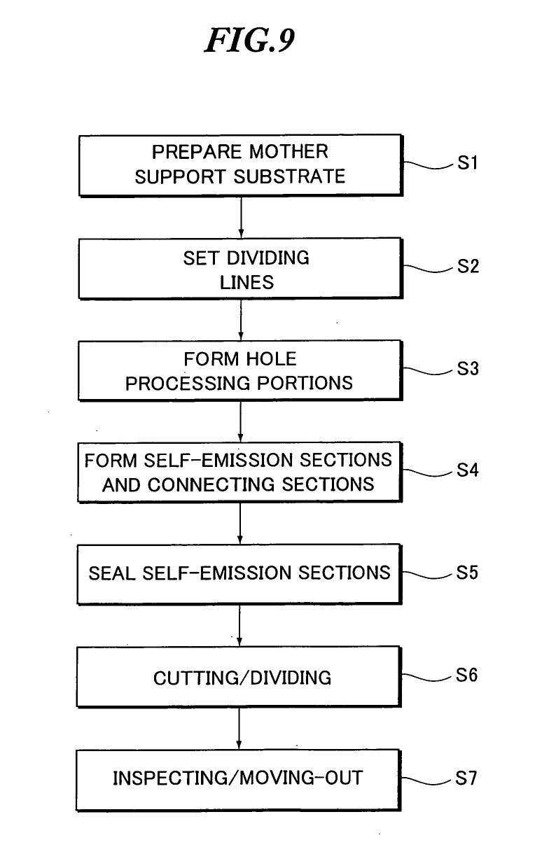

FIG. 9 is an explanatory flow chart showing a method of manufacturing self-emission panels according to an embodiment of the present invention.

At first, substrate introduction, cutting-out and surface treatment are performed in step S1 for preparing a mother support substrate 10m. Then, as described above, self-emission section forming regions 20 are set on the mother support substrate, followed by setting dividing lines L and La corresponding to the regions 2₀ (diving line setting step: S2). Subsequently, an etching or sandblasting is carried out on partial or entire bent dividing lines La, thereby effecting a hole processing by virtue of a laser beam or the like (hole processing portion forming step S3).

Afterwards, the self-emission sections 2 and the connecting sections 3 are formed on the mother support substrate 10m formed with the hole processing portions Pa (self-emission section and connecting section forming step: S4), followed by sealing the self-emission sections 2 (sealing step: S5). At sealing step S5, it is allowed to use a method in which the aforementioned sealing member 11 is bonded to the mother support substrate 10m, or a method in which the self-emission sections 2 are covered by a solid sealing member.

After that, cutting operation is performed along the dividing lines L (i.e., remaining portions when hole processing portions Pa are formed in part of the dividing lines La), thereby cutting out self-emission panels 1 (cutting step: S6). Subsequently, an inspection is performed to check the respective self-emission panels 1 which are then moved out as products (inspection and moving-out step: S7).

According to the above-described self-emission panel manufacturing method, it is possible to multi-face cut out a plurality of self-emission panels from a mother support substrate 10m, thereby making it possible to cut out a plurality of self-emission panels each having a concave/convex edge only by performing a linear cutting during a cutting/dividing process. In this way, it is possible to multi-face cut out a plurality of self-emission panels each having a concave/convex edge without any trouble such as cracking or the like.

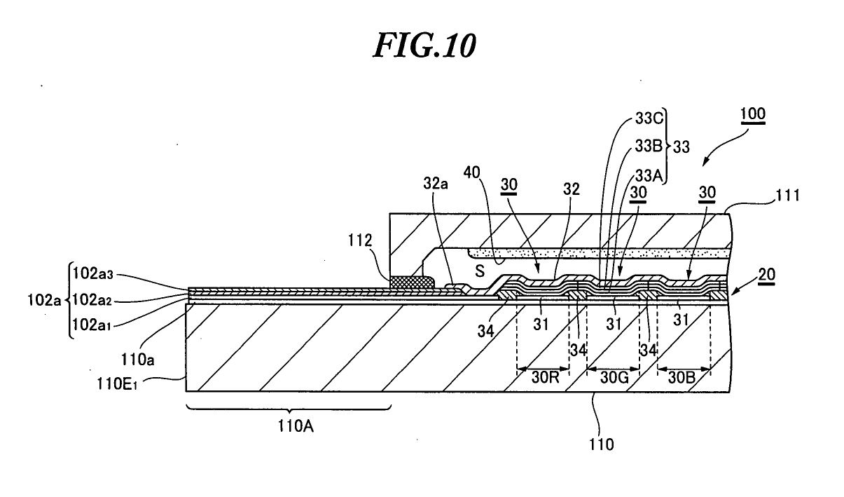

In the following, description will be given to explain a detailed structure of an organic EL panel serving as a detailed example of the above-described self-emission panel 1, with reference to FIG. 10.

As shown, an organic EL panel 100 is formed by interposing an organic layer 33 containing an organic luminescent layer between first electrodes 31 (lower electrodes) on one hand and second electrodes 32 (upper electrodes) on the other, thereby forming a plurality of organic EL elements 30 on the substrate 110. In an example as shown in the drawing, a silicone coating layer 110a is formed on the substrate 110, and a plurality of first electrodes 31 consisting of transparent electrode material such as ITO and serving as anodes are formed on the silicon coating layer 110a. Further, second electrodes 32 consisting of a metal such as Al and serving as cathodes are formed over the first electrodes 31, thereby forming a bottom emission type panel emitting light from the substrate 110 side. Moreover, the panel also contains an organic layer 33 including a positive hole transporting layer 33A, a luminescent layer 33B, and an electron transporting layer 33C. Then, a sealing cover 111 is bonded to the substrate 110 through an adhesive layer 112, thereby forming a sealing space S on the substrate 20 and thus forming self-emission section 20 consisting of organic EL element 30.

A self-emission section 20 consisting of organic EL element 30, as shown in the illustrated example, is so formed that its first electrodes 31 are divided by insulating strips 34, thereby forming a plurality of unit display areas (30R, 30G, 30B) by virtue of the respective organic EL elements 30 located under the divided first electrodes 31. Further, desiccating means 40 is attached to the inner surface of the sealing cover 40 forming the sealing space S, thereby preventing a deterioration of the organic EL elements which is possibly caused due to moisture.

Moreover, along the edge of the substrate 110 there is formed a protrusion area 110A on which there is formed a first electrode layer 102ₐ₁ using the same material and the same step as forming the first electrodes 31, which is isolated from the first electrodes 31 by the insulating strips 34. Further, on the lead-out portion of the first electrode layer 102ₐ₁ there is formed a second electrode layer 102ₐ₂ containing an Ag-alloy or the like and forming a low-resistant wiring portion. In addition, if necessary, a protection coating layer 102ₐ₃ consisting of IZO or the like is formed on the second electrode layer 102ₐ₂. In this way, a lead-out wiring portion 21 can be formed which consists of the first electrode layer 102ₐ₁, the second electrode layer 102ₐ₂, and the protection layer 102ₐ₃. Then, an end portion 32a of each second electrode 32 is connected to the lead-out wiring portion 102a within the sealing space S.

Here, although the lead-out wiring portion of each first electrode 31 is not shown in the drawing, such lead-out wiring portion can be formed by extending each first electrode 31 and leading the same out of the sealing space M. Actually, such a lead-out wiring portion can also be formed into an electrode layer containing an Ag-alloy or the like and constituting a low resistant wiring portion, in a manner similar to the above-described second electrode 32.

Next, an outer edge 110E₁ of the protrusion area 110A of the support substrate 110 is formed by virtue of hole processing edge described above.

Next, description will be given in more detail to explain the detailed portions of the aforementioned organic EL panel 100.

a. Electrodes

Either the first electrodes 31 or the second electrodes 32 are set as cathode side, while the opposite side is set as anode side. The anode side is formed by a material having a higher work function than the cathode side, using a transparent conductive film which may be a metal film such as chromium (Cr), molybdenum (Mo), nickel (nickel), and platinum (Pt), or a metal oxide film such as ITO and IZO. In contrast, the cathode side is formed by a material having a lower work function than the anode side, using a metal having a low work function, which may be an alkali metal (such as Li, Na, K, Rb, and Cs), an alkaline earth metal (such as Be, Mg, Ca, Sr, and Ba), a rare earth metal, a metal having a low work function or its compound, or an alloy containing two or more of the above elements, or an amorphous semiconductor such as a doped polyaniline and a doped polyphenylene vinylene, or an oxide such as Cr₂O₃, NiO, and Mn₂O₅. Moreover, when the first electrodes 31 and the second electrodes 32 are all formed by transparent materials, it is allowed to provide a reflection film on one electrode side opposite to the light emission side.

The lead-out wiring portions (the lead-out wiring portion 102a and the lead-out wiring portion of the first electrodes 31 shown in the drawing) are connected with drive circuit parts driving the organic EL panel 100 or connected with a flexible wiring board. However, it is preferable for these lead-out wiring portions to be formed as having a low resistance as possible. Namely, as described above, the lead-out wiring portions can be formed by laminating low resistant metal electrode layers which may be Ag-alloy, APC, Cr, Al, or the like. Alternatively, they maybe formed by single one electrode of low resistant metal using one of the foregoing materials.

b. Organic Layer

Although the organic layer 33 comprises one or more layers of organic compound materials including at least one organic luminescent layer, its laminated structure can be in any desired arrangement. Usually, it is possible to use a laminated structure including, from the anode side towards the cathode side, a hole transporting layer 33A, a luminescent layer 33B, and an electron transporting layer 33C. Each of the hole transporting layer 33A, the luminescent layer 33B, and the electron transporting layer 33C can be in a single-layer or a multi-layered structure. Moreover, it is also possible to dispense with the hole transporting layer 33A and/or the electron transporting layer 33C. On the other hand, if necessary, it is allowed to insert other organic layers such as a hole injection layer, an electron injection layer. Here, the hole transporting layer 33A, the luminescent layer 33B, and the electron transporting layer 33C can be formed by any conventional materials (it is allowed to use either a high molecular material or a low molecular material).

With regard to a luminescent material for forming the luminescent layer 33B, it is allowed to make use of a luminescence (fluorescence) when the material returns from a singlet excited state to a base state or a luminescence (phosphorescence) when it returns from a triplet excited state to a base state.

c. Sealing Cover (Sealing Film)

Further, the organic EL panel 100 according to the present invention is a panel formed by tightly covering organic EL elements 30 with a sealing cover 40 made of metal, glass, or plastic. Here, the sealing cover may be a piece of material having a recess portion (a one-step recess or a two-step recess) formed by pressing, etching, or blasting. Alternatively, the sealing cover maybe formed by using a flat glass plate and includes an internal sealing space S to be formed between the flat glass plate and the support substrate 110 by virtue of a spacer made of glass (or plastic).

d. Adhesive Agent

An adhesive agent forming the adhesive layer 41 may be a thermal-setting type, a chemical-setting type (2-liquid mixture), or a light (ultraviolet) setting type, which can be formed by an acryl resin, an epoxy resin, a polyester, a polyolefin. Particularly, it is preferable to use an ultraviolet-setting epoxy resin adhesive agent which is quick to solidify without a heating treatment.

e. Desiccating Means

Desiccating means 42 may be a physical desiccating agent such as zeolite, silica gel, carbon, and carbon nanotube; a chemical desiccating agent such as alkali metal oxide, metal halide, chlorine dioxide; a desiccating-agent formed by dissolving an organometal complex in a petroleum system solvent such as toluene, xylene, an aliphatic organic solvent and the like; and a desiccating agent formed by dispersing desiccating particles in a transparent binder such as polyethylene, polyisoprene, polyvinyl thinnate.

f. Various Types of Organic EL Display Panels

The organic EL panel 100 of the present invention can have various types without departing from the scope of the invention. For example, the light emission type of an organic EL element 30 can be a bottom emission type which emits light from the substrate 110 side, or a top emission type which emits light from sealing cover side 111 (at this time, it is necessary for the sealing cover 111 to be formed of a transparent material and to dispose the desiccating means 40). Moreover, the EL display panel 100 may be a single color display or a multi-color display. In practice, in order to form a multi-color display panel, it is allowed to adopt a discriminated painting method or a method in which a single color (white or blue) luminescent layer is combined with a color conversion layer formed by a color filter or a fluorescent material (CF manner, CCM manner), a photograph breeching method which realizes a multiple light emission by emitting an electromagnetic wave or the like to the light emission area of a single color luminescent layer, or SOLED (transparent Stacked OLED) method in which two or more colors of unit display areas are laminated to form one unit display area. Besides, it is possible to employ a laser transfer method in which low molecular organic materials having different luminescent colors are formed into films on different film layers so that they may be transferred to one substrate by virtue of thermal transfer based on the laser. In addition, although the above-illustrated examples show a passive driving type, it is also possible to employ an active driving type which uses a TFT substrate as the support substrate 110 and forms thereon a flattening layer, followed by forming thereon the first electrode layer 31.

According to the above-described embodiment of the present invention, each protrusion area is positioned on one side so as to save using additional area of self-emission panel substrate, thereby making it possible to ensure effective number of multi-faced unit panels. Further, by removing unwanted portions from support substrate, it is allowed to reduce an area occupied by self-emission panel with respect to display area, thereby rendering it possible to produce electronic device mounting self-emission panel which is compact in size and light in weight. Moreover, it is possible to prevent a trouble such as cracking or the like when cutting/dividing a mother support substrate, thereby ensuring a high productivity irrespective of a shape of a self-emission panel substrate.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A self-emission panel in which a sealed self-emission section is formed on a support substrate, and a connecting section formed with lead-out wiring portions led out from the self-emission section is formed outside the self-emission section on the support substrate,
wherein at least one outer edge of the support substrate has a concave/convex portion for sectioning on one side a protrusion area protruding from the self-emission section to form the connecting section,
wherein the concave/convex portion is partially or entirely formed by virtue of hole processing edge.

2. The self-emission panel according to claim 1,
wherein said support substrate is formed by cutting/dividing a mother support substrate formed with a plurality of self-emission sections,
wherein said hole processing edge is part of inner edge of hole processing portion formed in said mother support substrate.

3. The self-emission panel according to claim 1 or 2, wherein the concave/convex portion includes a lateral edge located away from the self-emission section, another lateral edge located close to the self-emission section, and a vertical edge for connecting together all the lateral edges.

4. The self-emission panel according to claim 3, wherein the concave/convex portion is such that its lateral edges are formed by virtue of cutting processing edge and its vertical edge is formed by virtue of hole processing edge.

5. A self-emission panel in which a plurality of sealed self-emission sections are formed on a mother support substrate, and connecting sections formed with lead-out wiring portions led out from the self-emission sections are formed outside the self-emission sections on the mother support substrate,
wherein bent dividing lines for sectioning in parallel protrusion areas protruding from neighboring self-emission sections to form the connecting sections are set in areas between neighboring self-emission sections on the mother support substrate,
wherein hole processing portions are formed along partial or entire bent dividing lines.

6. The self-emission panel according to claim S, wherein each bent dividing line includes a lateral line located away from one of neighboring self-emission sections, another lateral line located close to the one self-emission section, and a vertical line for connecting together all the lateral lines.

7. The self-emission panel according to claim 6, wherein said hole processing portions are formed along said vertical lines.

8. A method of manufacturing self-emission panels in which sealed self-emission sections are formed on support substrates, and connecting sections formed with lead-out wiring portions led out from the self-emission sections are formed outside the self-emission sections on the support substrates, said method comprising:
a step of setting dividing lines for linearly sectioning surrounding areas of self-emission section forming regions on a mother support substrate on which a plurality of self-emission sections are to be formed, setting bent dividing lines for sectioning in parallel connecting section forming regions corresponding to neighboring self-emission section forming regions in areas between neighboring self-emission section forming regions on the mother support substrate, and forming hole processing portions along partial or entire bent dividing lines;
a step of forming self-emission sections in the self-emission section forming regions on the mother support substrate and forming the connecting sections in the connecting section forming regions;
a step of sealing the self-emission sections formed on the mother support substrate; and
a step of linearly cutting/dividing the mother support substrate along said dividing lines to produce a plurality of self-emission panels.

9. The self-emission panel according to claim 8, wherein each bent dividing line includes a lateral line located away from one of neighboring connecting section forming regions, another lateral line located close to the one connecting section forming region, and a vertical line for connecting together all the lateral lines, while hole processing portions are formed along entire bent dividing lines.

10. The self-emission panel according to claim 8, wherein each bent dividing line includes a lateral line located away from one of neighboring connecting section forming regions, another lateral line located close to the one connecting section forming region, and a vertical line for connecting together all the lateral lines, while hole processing portion is formed along the vertical line.
